(19) United States
(12) Patent Application Publication
(10) Pub. No.: US 2002/0101565 A1
(43) Pub. Date: Aug. 1, 2002

(54) Multifocal lens capable of preventing distortion on edge of the lens with enlarging a nearsighted region

(76) Inventor: Kiyoshi Yamaguchi, Atami-shi (JP)

Correspondence Address: SHLESINGER, ARKWRIGHT & GARVEY LLP, 3000 South Eads Street, Arlington, VA, 22202, US

(21) Appl. No.: 09/876,123

(22) Filed: Jun. 8, 2001

(30) Foreign Application Priority Data
Jan. 29, 2001 (JP) 2001-19720

(51) Int. Cl. G02C 7/06

(52) U.S. Cl. 351/169; 351/168

(57) ABSTRACT

A multifocal lens has an outer surface and an inner surface. The outer surface has at least farsighted region and nearsighted region. The outer surface has an outer surface TC equal to 180 degrees. A thickness of the lens varies from the farsighted region to the nearsighted region in accordance with the outer surface TC. For example, the thickness of the lens increases from the farsighted region to the nearsighted region in accordance with the outer surface TC. The thickness of the lens is a constant in the farsighted region. As a result, it is possible to enlarge the nearsighted region an to prevent distortion in each edge of the lens.

### BACKGROUND OF THE INVENTION

The present invention relates a multifocal lens for use in bifocal glasses, and more particularly, to a multifocal lens capable of preventing distortion with a nearsighted region.

In general, an omni focal lens is known as a multifocal lens which has a farsighted region and a nearsighted region. Furthermore, a triple focal lens is known as another multifocal lens which has a farsighted region, a nearsighted region, and an intermediate region between the farsighted region and the nearsighted region. When a user uses glasses having such a multifocal lens, the user inevitably sees a sharp boundary line between the farsighted region (farsighted portion) and the nearsighted region (nearsighted portion). In order to extinguish the sharp boundary line, proposal is made about a first conventional multifocal lens whose frequency is progressively varied in an intermediate region of the first conventional multifocal lens.

In the first conventional multifocal lens, an outer curve (outer surface) defines a surface which is positioned at an observing object surface. The outer surface has a farsighted region and a nearsighted region. The farsighted region is positioned or formed on an upper portion of the first conventional multifocal lens. The nearsighted region is positioned or formed on a lower portion of the first conventional multifocal lens. The farsighted region is a spherical portion having a comparatively long radius of curvature. On the other hand, the nearsighted region is a spherical portion having a comparatively short radius of curvature. More particularly, the farsighted region has a first predetermined radius of curvature. The nearsighted region has a second predetermined radius of curvature which is shorter than the first predetermined radius of curvature.

In as much as the first predetermined radius of curvature is different from the second predetermined radius of curvature, the farsighted region has a thickness different from that of the nearsighted region, in the edge of the lens. As a result, distortion occurs in each side of the farsighted region. In the other words, it is impossible to avoid large astigmatic aberration and large distortion aberration in the farsighted region. More specifically, the astigmatic aberration and large distortion aberration cause the image of the object to appear blurred in a middle distance. Furthermore, the user feels that the image swings when the user moves the head of the user. As a result, unpleasantness is given to the user. In addition, each of the farsighted region and the nearsighted region becomes close on the basis of the astigmatic aberration and large distortion aberration.

In order to dissolve the above-mentioned problems, a multifocal lens is disclosed as a second conventional multifocal lens in Japanese Patent Publication No.3085664.

The second conventional multifocal lens has a non-spherical region whose radius of curvature is progressively varied in correspondence to the shape of outer curve. As will be described later, the nearsighted region becomes close or narrow although it is possible to enlarge the farsighted region and it is possible to dissolve the distortion in the non-spherical region. As a result, the distortion inevitably occurs in each side of the lens.

### SUMMARY OF THE INVENTION

It is therefore an object of the present invention to provide a multifocal lens capable of enlarging a nearsighted region.

It is another object of the present invention to provide to prevent distortion in each side of lens.

Other objects of the present invention become clear as the description will proceed.

According to the present invention, there is provided a multifocal lens having an outer surface and an inner surface. The outer surface has at least farsighted region and nearsighted region. The outer surface has an outer surface TC equal to 180 degrees. A thickness of the lens varies from the farsighted region to the nearsighted region in accordance with the outer surface TC.

The thickness of the lens may increase from the farsighted region to the nearsighted region in accordance with the outer surface TC. The thickness of the lens is a constant in the farsighted region. A progressive zone is formed between the farsighted region and the nearsighted region. The progressive zone is a non-spherical portion. A band shaped region may be formed between the farsighted region and the nearsighted region. The band shaped region has a radius of curvature that progressively varies.

### BRIEF DESCRIPTION OF THE DRAWINGS

FIG. 1 shows a sectional view for illustrating a conventional multifocal lens;

FIG. 2 shows a view of an inner surface of the lens illustrated in FIG. 1;

FIG. 3 shows a sectional view for illustrating a multifocal lens according a preferred embodiment of the present invention; and

FIG. 4 shows a view of an outer surface of the lens illustrated in FIG. 3.

### DESCRIPTION OF THE PREFERRED EMBODIMENT

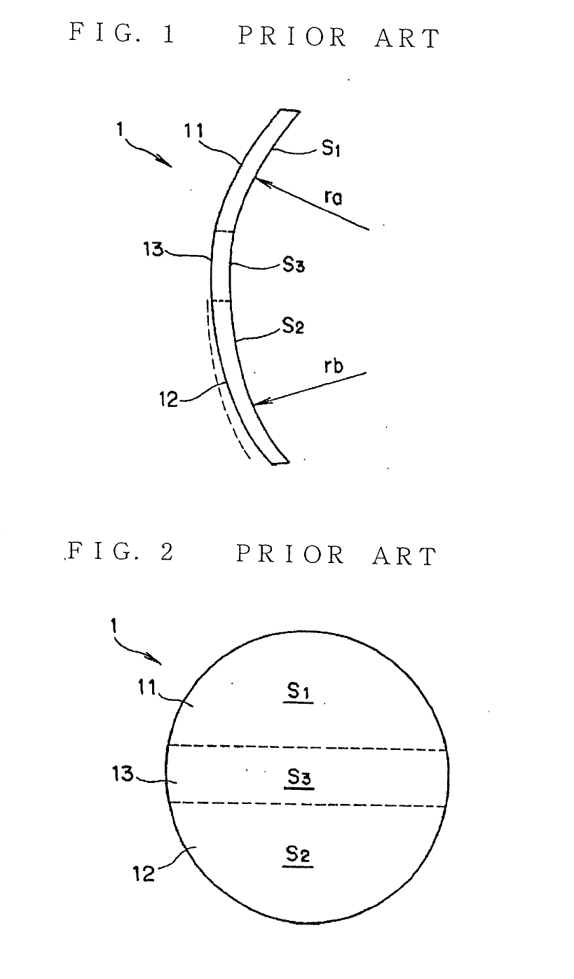

Referring to FIGS. 1 and 2, description will first be made as regards a conventional multifocal lens in order to facilitate an understanding of the present invention. The illustrated multifocal lens comprises of a farsighted region 11, a nearsighted region 12, and a progressive zone 13. The farsighted region 11 expands to an upper portion and each side portion of the lens. The nearsighted region 12 is positioned at a central lower portion of the lens. The progressive zone 13 is positioned between the farsighted region 11 and the nearsighted region 12 and may be called an intermediate progressive nearsighted region. In the farsighted region, the outer surface (outer curve) is formed to a spherical portion which has a comparatively long predetermined radius of curvature. In the nearsighted region 12, the outer surface is formed to a spherical portion which has a comparatively short predetermined radius of curvature. In the progressive zone 13, the outer surface is formed to a non-spherical portion whose radius of curvature monotonously decreases. More particularly, the progressive zone 13 has a curvature which monotonously decreases from the boundary between the farsighted region 11 and the progressive zone 13, to the boundary between the nearsighted region 12 and the progressive region 13. In FIG. 1, a broken line illustrated in the nearsighted region 12 is representative of an extended line of the spherical surface of the farsighted region 11.

As shown in FIG. 2, the inner surface (inner curve) of the multifocal lens 1 comprises of a first spherical portion S1, a second spherical portion S2, and a non-spherical portion S3 in correspondence to the form of the outer surface of the lens. More specifically, the first spherical portion S1 corresponds to the farsighted region 11 and has a first radius (ra) as the radius of curvature. The second spherical portion S2 corresponds to the nearsighted region 12 and has a second radius (rb) as the radius of curvature. The non-spherical portion S3 corresponds to the progressive zone 13 and has the radius of curvature which varies between the first radius and the second radius. The non-spherical portion S3 is formed to a swath shape which is positioned at a central portion of the lens and which extends towards right and left directions of FIG. 2. The radius of curvature monotonously reduces in the non-spherical portion S3 from the upper portion to the lower portion of the lens in FIG. 2.

As described above, the illustrated multifocal lens has the non-spherical region whose radius of curvature is progressively varied in correspondence to the shape of outer curve. The nearsighted region becomes close or narrow although it is possible to enlarge the farsighted region and it is possible to dissolve the distortion in the non-spherical region. As a result, the distortion inevitably occurs in each side of the lens.

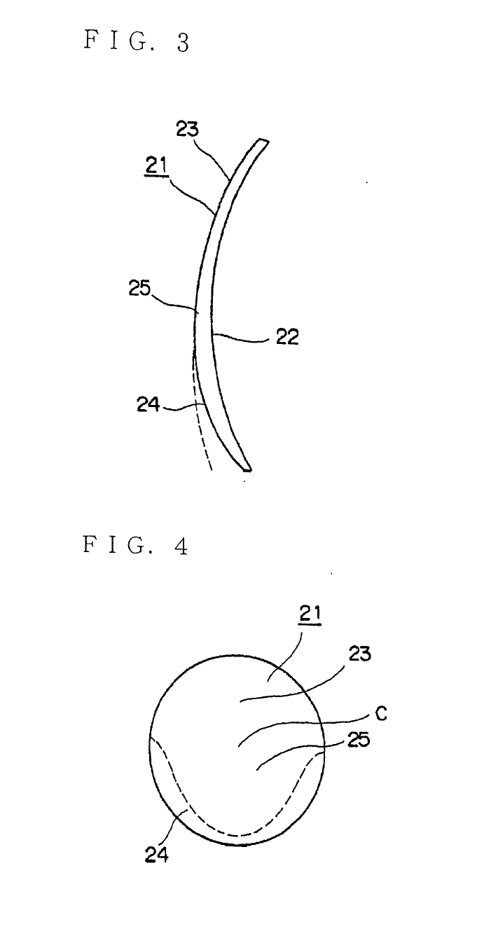

Referring to FIGS. 3 and 4, description will proceed to a multifocal lens according to a preferred embodiment of the present invention. On manufacturing the multifocal lens, a lens is prepared which has an outer surface and inner surface of TC. More particularly, the lens of the outer surface TC has the outer surface whose TC is equal to 180 degrees. The lens of the outer surface TC is shaped into the multifocal lens by cutting process.

The illustrated multifocal lens comprises of an outer surface 21 which is for use in a surface for observing an object. The outer surface 21 has a farsighted region 23, a nearsighted region 24, and a progressive zone 25. The farsighted region 23 is positioned at an upper portion of the lens. The nearsighted region 24 is positioned at a lower portion of the lens. The progressive zone 25 is positioned between the farsighted region 23 and the nearsighted region 25 and may be called an intermediate progressive nearsighted region. In FIG. 3, a broken line is representative of an extended line of the farsighted region 23.

As shown in FIG. 4, the farsighted region 23 expands to an upper portion and each side portion of the outer surface 21. A portion labeled “C” in FIG. 4 defines a boundary between the farsighted region 23 and the progressive zone 25. A region, which is positioned at a lower region of the portion “C”, is used as the nearsighted region illustrated by a reference numeral 24 in FIG. 3. The nearsighted region 12 extends near the central portion of the edge of the outer surface 21 along the edge of the outer surface 21, from the lower end of the outer surface 21. In the other words, the progressive zone 25 extends near the lower end of the outer surface 21. The nearsighted region 24 extends upwardly along the each edge of the outer surface 21, from the lower end of the outer surface 21 so as to surround the progressive zone 25.

Again referring to FIG. 3, the outer surface TC affects the farsighted region 23 in case where of using the lens whose outer surface TC is equal to 180 degrees. In other words, TC of 180 degrees appears on the farsighted region 23. Similarly, the outer surface TC affects each of the nearsighted region 24 and the progressive zone 25 in case where of using the lens whose outer surface TC is equal to 180 degrees.

Under the circumstances, the farsighted region has a thickness which is thinner than that of the nearsighted region 24 in the being illustrated in FIGS. 3 and 4. More particularly, the thickness of the lens is varied from the nearsighted region 24 to the farsighted region 23 in accordance with the outer surface TC. In FIG. 3, the thickness of the lens gradually becomes thick from the farsighted region 23 to the lower direction in accordance with outer surface TC. The thickness of the lens is a constant in the farsighted region 23. As described above, the thickness of the lens gradually becomes thick with directing from the farsighted region 23 to the nearsighted region 24.

On varying the thickness of the lens as described above, the outer surface of the lens is cut away from the farsighted region 23 to the nearsighted region 24 by a cutting jig. In FIG. 3, the cutting amount is diminished in the nearsighted region 24 in comparison to the farsighted region 23.

Before cutting, the farsighted region 23 is a spherical portion which has a comparatively long predetermined radius of curvature (first radius of curvature). The nearsighted region 12 is a spherical portion which has a comparatively short predetermined rudis of curvature (second radius of curvature). The second radius of curvature is not greater than the first radius of curvature. Furthermore, the progressive zone 13 has a radius of curvature that monotonously decreases from the farsighted region 23 to the nearsighted region 24. For Example, the progressive zone 13 is a non-spherical portion.

As described above, the thickness of the lens is a constant in the farsighted region 23 and the thickness of the lens gradually becomes thick in accordance with the surface TC from the farsighted region 23 towards to the near sighted region 24, using the lens whose outer surface TC is equal to 180 degrees. As a result, it is possible to remove an affect based on the outer surface TC, in the farsighted region 23 even if the outer surface TC is a constant (even if the outer surface TC is equal to 180 degrees). Furthermore, it is possible to enlarge the nearsighted region 24 and to easily form the nearsighted region 24 inasmuch as the outer surface TC is a constant. In addition, it is possible to prevent the distortion in each edge of the lens inasmuch as the outer surface TC is a constant.

As described above, it is possible to enlarge the nearsighted region and to prevent the distortion in each edge of the lens according to the present invention inasmuch as the thickness of the lens gradually becomes thick from the farsighted region towards the nearsighted region in the lens having the farsighted region and the nearsighted region, using the lens whose outer surface TC is a constant (180 degrees).

In other words, it is possible to enlarge the nearsighted region and to prevent the distortion in each edge of the lens according to the present invention inasmuch as the thickness of the lens gradually becomes thick from the farsighted region towards the nearsighted region in accordance with the outer surface TC, using the lens whose outer surface TC is a constant (180 degrees).

While the present invention has thus far been described in conjunction with the preferred embodiment thereof, it will readily be possible for those skilled in the art to put the present invention into practice in various other manner.

What is claimed is:

1. A multifocal lens having an outer surface and an inner surface, said outer surface having at least farsighted region and nearsighted region, wherein:
said outer surface has an outer surface TC equal to 180 degrees; and
a thickness of the lens varying from said farsighted region to said nearsighted region in accordance with said outer surface TC.

2. A multifocal lens as claimed in claim 1, wherein the thickness of the lens increases from said farsighted region to said nearsighted region in accordance with said outer surface TC.

3. A multifocal lens as claimed in claim 1, wherein the thickness of the lens is a constant in said farsighted region.

4. A multifocal lens as claimed in claim 2, wherein:
a progressive zone is formed between said farsighted region and said nearsighted region; and
said progressive zone being a non-spherical portion.

5. A multifocal lens as claimed in claim 2, wherein:
a band shaped region is formed between said farsighted region and said nearsighted region; and
said band shaped region having a radius of curvature that progressively varies.
